(19) United States
(12) Patent Application Publication
(10) Pub. No.: US 2024/0208159 A1
(43) Pub. Date: Jun. 27, 2024

(54) FILAMENT WINDING DEVICE AND FILAMENT WINDING METHOD

(71) Applicant: HONDA MOTOR CO., LTD., TOKYO (JP)

(72) Inventor: Koei FUJIKI, WAKO-SHI (JP)

(21) Appl. No.: 18/395,586

(22) Filed: Dec. 24, 2023

(30) Foreign Application Priority Data
Dec. 27, 2022 (JP) 2022-209135

(51) Int. Cl. B29C 70/38; B29C 70/86; F17C 13/00

(52) U.S. Cl. CPC B29C 70/382; B29C 70/86; F17C 13/00; B29L 2031/7156

(57) ABSTRACT

A filament winding device winds a fiber member on an outer peripheral surface of a hollow resin liner in a state where the inside of the liner is pressurized. The filament winding device includes an acquisition unit that acquires a physical quantity indicating an outer dimension of a fiber layer formed by winding the fiber member around the liner, during winding of the fiber member, and a pressure control unit that controls an internal pressure of the liner in a manner so that the outer dimension approaches a predetermined target value, during winding of the fiber member.

### CROSS-REFERENCE TO RELATED APPLICATIONS

This application is based upon and claims the benefit of priority from Japanese Patent Application No. 2022-209135 filed on Dec. 27, 2022, the contents of which are incorporated herein by reference.

### BACKGROUND OF THE INVENTION

### Field of the Invention

The present invention relates to a filament winding device and a filament winding method.

### Description of the Related Art

In recent years, research and development have been conducted on fuel cell systems that contribute to energy efficiency in order to ensure that more people have access to affordable, reliable, sustainable and modern energy. A fuel cell system is provided with a gas tank for filling hydrogen gas.

This type of gas tank is manufactured by a filament winding method. For example, JP 2021-148168 A discloses a filament winding method of forming a fiber layer by winding a fiber member around a hollow resin liner in a state where the inside of the liner is pressurized. According to this filament winding method, the liner can be prevented from being crushed inward by the winding force of the fiber member.

### SUMMARY OF THE INVENTION

When the fiber member is wound around the hollow resin liner in a state where the inside of the liner is simply pressurized, a satisfactory gas tank cannot be necessarily manufactured.

An object of the present invention is to solve the aforementioned problem.

A filament winding device according to an aspect of the present invention is configured to wind a fiber member on an outer peripheral surface of a liner made of resin and having a hollow shape in a state where an inside of the liner is pressurized, and includes an acquisition unit configured to acquire a physical quantity indicating an outer dimension of a fiber layer formed by winding the fiber member around the liner, during winding of the fiber member, and a pressure control unit configured to control an internal pressure of the liner in a manner so that the outer dimension approaches a predetermined target value, during winding of the fiber member.

Another aspect of the present invention is a filament winding method of winding a fiber member on an outer peripheral surface of a liner made of resin and having a hollow shape in a state where an inside of the liner is pressurized. The filament winding method includes acquiring a physical quantity indicating an outer dimension of a fiber layer formed by winding the fiber member around the liner, during winding of the fiber member, and controlling an internal pressure of the liner in a manner so that the outer dimension approaches a predetermined target value, during winding of the fiber member.

According to the present invention, since the internal pressure of the liner is controlled such that the outer dimension of the fiber layer approaches the predetermined target value, it is possible to appropriately maintain the balance between the internal pressure of the liner and the winding force of the fiber member by simple control. Therefore, when the internal pressure of the liner is lowered after finishing winding of the fiber member, it is possible to suppress the formation of a gap between the fiber layer and the liner. Therefore, a satisfactory gas tank can be manufactured.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a configuration of a filament winding device according to an embodiment of the present invention;

FIG. 2A is a vertical longitudinal cross-sectional view sectional view of a gas tank manufactured using the filament winding device of FIG. 1;

FIG. 2B is a partially enlarged cross-sectional view of FIG. 2A;

FIG. 3 is an explanatory diagram of the outer dimension of the fiber layer intermediate portion;

FIG. 4 is an explanatory diagram of the outer dimensions of the fiber layer end portion; and

FIG. 5 is a flowchart illustrating a filament winding method according to an embodiment of the present invention.

### DETAILED DESCRIPTION OF THE INVENTION

In the conventional filament winding method, it is not easy to maintain a balance between the internal pressure of the liner and the winding force of the fiber member. If the internal pressure becomes excessively greater or smaller than the winding force during winding of the fiber member, a gap may be formed between the fiber layer and the liner when the internal pressure of the liner is lowered after the winding is completed. If an excessive gap is formed between the fiber layer and the liner, a gas tank having a sufficient pressure resistance cannot be obtained.

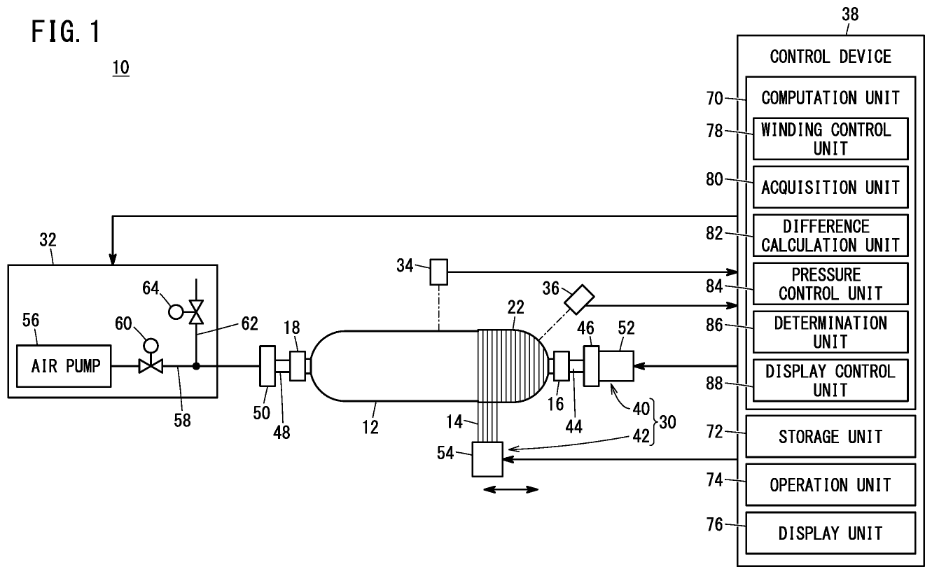

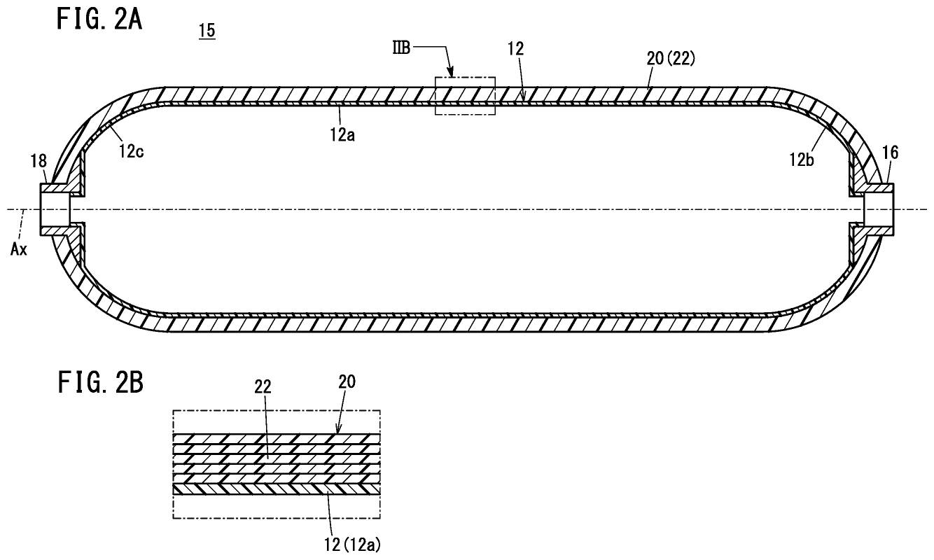

A filament winding device and a filament winding method according to an embodiment of the present invention will be described below with reference to the drawings. As shown in FIG. 1, a filament winding device (hereinafter referred to as a “FW device 10”) according to the present embodiment is a device for manufacturing a gas tank 15 (see FIG. 2A) by winding a fiber member 14 around the outer peripheral surface of a liner 12. The gas tank 15 manufactured by the FW device 10 is mounted on, for example, a fuel cell vehicle. In this case, the gas tank 15 is a high-pressure gas tank filled with hydrogen gas at a high pressure. The gas tank 15 may be filled with a fuel gas other than the hydrogen gas.

As shown in FIG. 2A, the gas tank 15 includes a hollow resin liner 12, a first cap 16, a second cap 18, and a reinforcing portion 20. The liner 12 is made of, for example, high-density polyethylene (HDPE) or nylon resin (PA6) that suppresses the permeation of hydrogen gas.

The liner 12 has a liner intermediate portion 12a, a first liner end portion 12b, and a second liner end portion 12c. The liner intermediate portion 12a is formed in a cylindrical shape. The first liner end portion 12b is provided at one end portion of the liner intermediate portion 12a. The second liner end portion 12c is provided at another end portion of the liner intermediate portion 12a. Each of the first liner end portion 12b and the second liner end portion 12c is formed in a hemispherical shape. The first cap 16 is attached to the first liner end portion 12b. The second cap 18 is attached to the second liner end portion 12c. The reinforcing portion 20 has a plurality of fiber layers 22 layered in the thickness direction of the liner 12 (see FIG. 2B).

As shown in FIG. 1, the FW device 10 includes a winding device 30, a pressure applying device 32, a first distance measuring sensor 34, a second distance measuring sensor 36, and a control device 38. The winding device 30 winds the fiber member 14 around the outer peripheral surface of the liner 12 while rotating the liner 12 about the axis Ax (see FIG. 2A) of the liner 12. The winding device 30 has a liner support portion 40 and a fiber member delivery unit 42.

The liner support portion 40 includes a first support shaft 44, a first support base 46, a second support shaft 48, a second support base 50, and a motor 52. The first support shaft 44 is detachably attached to the first base 16. The first support shaft 44 is, for example, a solid member. The first support base 46 rotatably supports the first support shaft 44. The second support shaft 48 is detachably attached to the second cap 18. The second support shaft 48 is, for example, a hollow pipe. The second support base 50 rotatably supports the second support shaft 48. The motor 52 is fixed to the first support base 46. The motor 52 integrally rotates the first support shaft 44, the liner 12, and the second support shaft 48 about an axis Ax of the liner 12.

The fiber member delivery unit 42 has a supply head 54 for supplying the fiber member 14 toward the outer peripheral surface of the liner 12. The supply head 54 is movable (traversable) along the axial direction of the liner 12. The fiber member 14 is made of a fiber reinforced plastic. The fiber member 14 is a fiber bundle formed by bundling a large number of fibers. As the fibers forming the fiber bundle, for example, carbon fibers or glass fibers are used. The fiber bundle is previously impregnated with a resin. As the resin with which the fiber bundle is impregnated, for example, an epoxy resin which is a thermosetting resin is used. Such a fiber bundle is referred to as tow prepreg.

The winding device 30 winds the fiber member 14 on the outer peripheral surface of the liner 12 by rotating the liner 12 about the axis Ax of the liner 12 and by feeding the fiber member 14 from the supply head 54 while moving the supply head 54 in the axial direction of the liner 12. The fiber layers 22 forming the reinforcing portion 20 are formed by winding the fiber member 14 on the outer peripheral surface of the liner 12. At this time, a relatively large winding force directing radially inward from the fiber member 14 acts on the liner 12.

The pressure applying device 32 supplies compressed air to the inside of the liner 12 in order to suppress radially inward deformation of the liner 12 due to the winding force of the fiber member 14. As a result, the interior of the liner 12 is pressurized. The pressure applying device 32 has an air pump 56, a supply path 58, a supply valve 60, an exhaust path 62, and an exhaust valve 64. The air pump 56 supplies compressed air to the supply path 58. The supply path 58 guides the compressed air supplied from the air pump 56 to the inside of the liner 12 through the inside of the hollow second support shaft 48.

The supply valve 60 is provided in the supply path 58. The supply valve 60 opens and closes the supply path 58. The supply valve 60 is an automatic valve driven by an output signal from the control device 38. The supply valve 60 is, for example, a solenoid valve. The supply valve 60 may be a control valve capable of adjusting the opening degree of the valving element.

The exhaust path 62 is connected to the supply path 58 on a downstream side of the supply valve 60. The exhaust path 62 communicates with outside air. The exhaust valve 64 is provided in the exhaust path 62. The exhaust valve 64 opens and closes the exhaust path 62. The exhaust valve 64 is an automatic valve driven by an output signal from the control device 38. The exhaust valve 64 is, for example, a solenoid valve. The exhaust valve 64 may be a control valve capable of adjusting the opening degree of the valving element.

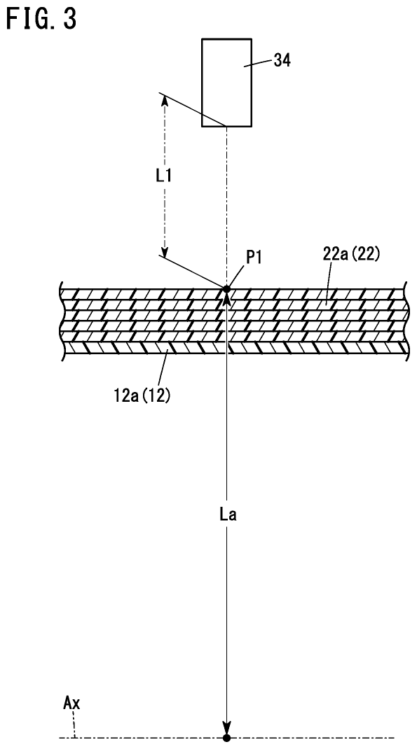

As shown in FIG. 3, the first distance measuring sensor 34 faces the liner intermediate portion 12a. The first distance measuring sensor 34 measures a first distance L1 which is a linear distance between a first measurement point P1 and the first distance measuring sensor 34. The first measurement point P1 is a point located on the outermost surface of a fiber layer intermediate portion 22a formed by winding the fiber member 14 around the liner intermediate portion 12a. The first distance measuring sensor 34 is a non-contact sensor. The first distance measuring sensor 34 is a distance measuring sensor using laser light.

Specifically, the first distance measuring sensor 34 is, for example, a laser displacement meter using spot-shaped laser light. However, the first distance measuring sensor 34 may be a laser displacement meter using band-shaped (line-shaped) laser light. The first distance measuring sensor 34 is not limited to the laser displacement meter, and may be a stereo camera or the like. The first distance measuring sensor 34 supplies the measured first distance L1 (first measurement signal) to the control device 38.

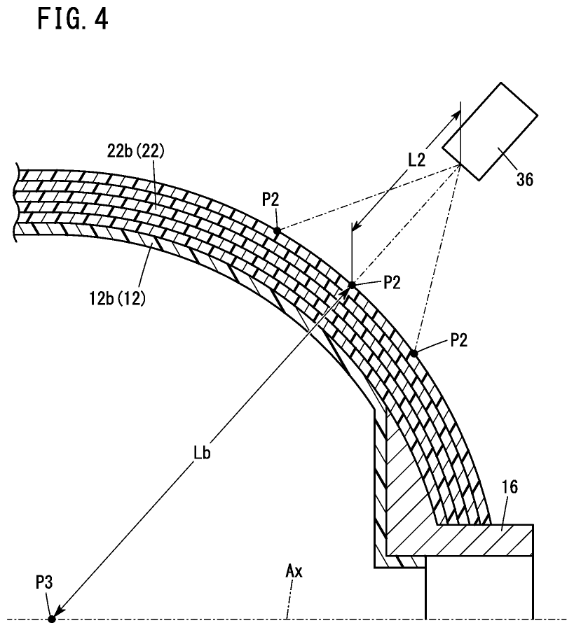

As shown in FIG. 4, the second distance measuring sensor 36 faces the first liner end portion 12b. The second distance measuring sensor 36 measures a second distance L2 which is a linear distance between a second measurement point P2 and the second distance measuring sensor 36. The second measurement point P2 is a point located on the outermost surface of a fiber layer end portion 22b formed by winding the fiber member 14 around the first liner end portion 12b. The second distance measuring sensor 36 is a non-contact sensor. The second distance measuring sensor 36 is a distance measuring sensor using laser light.

Specifically, the second distance measuring sensor 36 is, for example, a laser displacement meter using line-shaped laser light. In this case, the second distance measuring sensor 36 irradiates the fiber layer end portion 22b with line-shaped laser light along the axial direction of the liner 12. Therefore, the second distance measuring sensor 36 can measure the second distance L2 at each of the plurality of second measurement points P2 on the outermost surface of the fiber layer end portion 22b.

The number of the second measurement points P2 measured by the second distance measuring sensor 36 can be set as appropriate. The irradiation range of the laser light to be irradiated to the fiber layer end portion 22b can be set as appropriate. The second distance measuring sensor 36 may be a laser displacement meter using spot-shaped laser light. The second distance measuring sensor 36 is not limited to the laser displacement meter, and may be a stereo camera or the like. The second distance measuring sensor 36 supplies the measured second distances L2 (second measurement signal) to the control device 38.

In FIG. 1, the control device 38 includes a computation unit 70, a storage unit 72, an operation unit 74, and a display unit 76. The computation unit 70 may be configured by a processor such as a central processing unit (CPU) or a graphics processing unit (GPU). More specifically, the computation unit 70 can be configured by a processing circuitry.

The computation unit 70 includes a winding control unit 78, an acquisition unit 80, a difference calculation unit 82, a pressure control unit 84, a determination unit 86, and a display control unit 88. The acquisition unit 80, the difference calculation unit 82, the pressure control unit 84, the determination unit 86, and the display control unit 88 can be realized by the computation unit 70 executing the program stored in the storage unit 72.

At least a part of the winding control unit 78, the acquisition unit 80, the difference calculation unit 82, the pressure control unit 84, the determination unit 86, and the display control unit 88 may be realized by an integrated circuit such as an application specific integrated circuit (ASIC) or a field-programmable gate array (FPGA). It should be noted that at least a part of the winding control unit 78, the acquisition unit 80, the difference calculation unit 82, the pressure control unit 84, the determination unit 86, and the display control unit 88 may be realized by an electronic circuit including a discrete device.

The storage unit 72 includes a non-illustrated volatile memory, and a non-illustrated non-volatile memory. Examples of the volatile memory include, for example, a RAM (Random Access Memory) or the like. The volatile memory is used as a working memory of the processor, and temporarily stores data or the like required for processing or calculations. Examples of the nonvolatile memory include, for example, a ROM (Read Only Memory), a flash memory, or the like. The non-volatile memory is used as a storage memory, and stores therein programs, tables, maps, and the like. At least a portion of the storage unit 72 may be provided in the processor, the integrated circuit, or the like, which were described above.

The operation unit 74 is used when the user operates the FW device 10. As examples of the operating unit 74, there may be cited a keyboard, a mouse or the like; however, the present invention is not limited to this feature.

A non-illustrated display element may be provided in the display unit 76. As such a display element, there may be used, for example, a liquid crystal display element, an organic electroluminescence display element, or the like. The operation unit 74 and the display unit 76 may be constituted by a non-illustrated touchscreen that is equipped with such a display element.

The winding control unit 78 controls the winding device 30. Specifically, the winding control unit 78 controls the operation of the motor 52 and the supply head 54.

As shown in FIG. 3, the acquisition unit 80 acquires the outer dimension of the fiber layer intermediate portion 22a (hereinafter referred to as an “intermediate outer dimension La”) based on the first distance L1 (physical quantity) supplied from the first distance measuring sensor 34 during winding of the fiber member 14. The intermediate outer dimension La is a dimension along the radial direction of the liner 12. The intermediate outer dimension La is, for example, a radius of the fiber layer intermediate portion 22a.

As shown in FIG. 4, the acquisition unit 80 acquires the outer dimensions (hereinafter referred to as “end portion outer dimensions Lb”) of the plurality of portions of the fiber layer end portion 22b based on the plurality of second distances L2 (physical quantity) supplied from the second distance measuring sensor 36. The end portion outer dimensions Lb include, for example, a dimension along a direction intersecting the axial direction and the radial direction of the liner 12. The end portion outer dimensions Lb change when at least one of the dimension along the axial direction of the liner 12 or the dimension along the radial direction of the liner 12 changes. The end portion outer dimensions Lb are, for example, linear distances between a reference point P3 located on the axis Ax of the liner 12 and second measurement points P2. Also, the end portion outer dimensions Lb may include a dimension along the axial direction of the liner 12 or a dimension along the radial direction of the liner 12.

The difference calculation unit 82 (see FIG. 1) calculates a difference (hereinafter referred to as a “first difference”) between the intermediate outer dimension La and a predetermined first target value corresponding to the first measurement point P1. The difference calculation unit 82 calculates the first difference by subtracting the first target value from the intermediate outer dimension La, for example. The difference calculation unit 82 may calculate the first difference by subtracting the intermediate outer dimension La from the first target value.

The difference calculation unit 82 acquires a first target value corresponding to the winding amount of the fiber member 14 based on a predetermined first target value acquisition map. The first target value acquisition map is stored in the storage unit 72. The first target value acquisition map shows, for example, a relationship between the winding amount of the fiber member 14 and the first target value. The winding amount may be the winding amount of each fiber layer 22 or the cumulative amount after the start of winding. The first target value is the intermediate outer dimension La when the liner 12 is not deformed. The difference calculation unit 82 can grasp the winding amount of the fiber member 14 based on, for example, the number of rotations of the motor 52 or the like after the winding of the fiber member 14 is started.

The difference calculation unit 82 calculates a difference (hereinafter referred to as a “second difference”) between each of the plurality of predetermined second target values corresponding to the plurality of second measurement points P2 and each of the plurality of end portion outer dimensions Lb. The difference calculation unit 82 calculates the second differences by subtracting the second target values from the end portion outer dimensions Lb, respectively, for example. The difference calculation unit 82 may calculate the second differences by subtracting the end portion outer dimensions Lb from the second target values, respectively.

The difference calculation unit 82 acquires second target values corresponding to the winding amount of the fiber member 14 based on a predetermined second target value acquisition map. The second target value acquisition map is stored in the storage unit 72. The second target value acquisition map shows, for example, a relationship between the winding amount of the fiber member 14 and the plurality of second target values. The second target values are the end portion outer dimensions Lb when the liner 12 is not deformed. The setting of the first target value acquisition map and the second target value acquisition map is not limited to the example using the winding amount of the fiber member 14, and may use, for example, a layer angle (winding angle) or a folded position of the fiber member 14 at the first liner end portion 12b.

The pressure control unit 84 controls the operation of the pressure applying device 32. Specifically, the pressure control unit 84 drives and stops the air pump 56. The pressure control unit 84 controls the operation of each of the supply valve 60 and the exhaust valve 64. The pressure control unit 84 feedback-controls the pressure inside the liner 12 so that the outer dimensions acquired by the acquisition unit 80 approach the target values. The pressure control unit 84 may not perform the feedback control as long as the pressure inside the liner 12 is controlled so that the outer dimensions acquired by the acquisition unit 80 approach the target values.

Specifically, the pressure control unit 84 controls the operation of the supply valve 60 and the exhaust valve 64 so that the absolute value of the first difference is less than a first difference threshold value and the absolute values of the second differences are less than second difference threshold values. The first difference threshold value and the second difference threshold values are determined in advance and stored in the storage unit 72. When the internal pressure of the liner 12 is greater than the winding force of the fiber member 14, the first difference and the second differences are positive values, for example. When the first difference and the second differences are positive values, the pressure control unit 84 controls the operation of the supply valve 60 and the exhaust valve 64 so that the internal pressure of the liner 12 decreases. On the other hand, when the internal pressure of the liner 12 is smaller than the winding force of the fiber member 14, the first difference and the second differences become negative values, for example. When the first difference and the second differences are negative values, the pressure control unit 84 controls the operation of the supply valve 60 and the exhaust valve 64 so that the internal pressure of the liner 12 increases.

The determination unit 86 determines whether or not the winding of the fiber member 14 is completed.

The display control unit 88 controls the display of the display unit 76. The display control unit 88 displays, for example, the control state of the internal pressure, the winding state (winding progress rate) of the fiber member 14, and the like on a display screen (not shown) of the display unit 76.

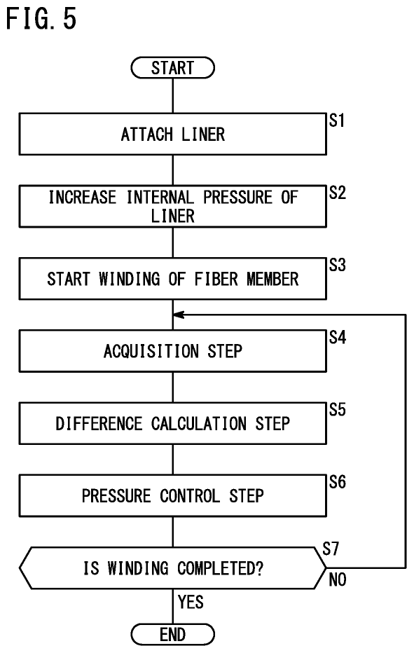

Next, a filament winding method according to the present embodiment will be described with reference to FIG. 5.

In step S1 of FIG. 5, the liner 12 is attached to the winding device 30. Thereafter, the process transitions to step S2.

In step S2, the interior of the liner 12 is pressurized. Specifically, the pressure control unit 84 controls the operation of the supply valve 60 to open the supply path 58 and controls the operation of the exhaust valve 64 to close the exhaust path 62. The pressure control unit 84 drives the air pump 56. When the air pump 56 is driven, compressed air is supplied to the interior of the liner 12 through the supply path 58 and the interior of the hollow second support shaft 48. This process increases the internal pressure of the liner 12. Thereafter, the process transitions to step S3.

In step S3, the winding of the fiber member 14 around the liner 12 is started. That is, the winding control unit 78 controls the motor 52 to rotate the liner 12 and controls the supply head 54 to move the supply head 54 along the axial direction of the liner 12. As a result, the fiber member 14 is wound around the liner 12. The fiber member 14 is wound around the liner 12 by way of hoop winding or helical winding. Thereafter, the process transitions to step S4.

In step S4, an acquisition step is performed. In the acquisition step, the acquisition unit 80 acquires the first distance L1 of the first measurement point P1 during winding of the fiber member 14. The acquisition unit 80 acquires the intermediate outer dimension La (see FIG. 3) based on the first distance L1. The acquisition unit 80 acquires the respective second distances L2 of the second measurement points P2 during winding of the fiber member 14. The acquisition unit 80 acquires a plurality of end portion outer dimensions Lb (see FIG. 4) based on the plurality of second distances L2. Thereafter, the process transitions to step S5.

In step S5, a difference calculation step is performed. In the difference calculation step, the difference calculation unit 82 calculates a first difference by subtracting the first target value from an intermediate outer dimension La. The difference calculation unit 82 calculates the plurality of second differences by subtracting the plurality of second target values from the plurality of end portion outer dimensions Lb, respectively. The first difference and the second differences are positive values when the internal pressure of the liner 12 is greater than the winding force of the fiber member 14, and are negative values when the internal pressure of the liner 12 is less than the winding force of the fiber member 14. Thereafter, the process transitions to step S6.

In step S6, a pressure control step is performed. In the pressure control step, the pressure control unit 84 feedback-controls the internal pressure of the liner 12 so that the absolute value of the first difference is less than the first difference threshold value and the absolute values of the second differences are less than the second difference threshold values. In other words, the pressure control unit 84 feedback-controls the internal pressure of the liner 12 so that the intermediate outer dimension La approaches the first target value and the end portion outer dimensions Lb approach the second target values.

Specifically, when the first difference is a positive value and each of the second differences is a positive value, the pressure control unit 84 controls the operation of the supply valve 60 and the exhaust valve 64 to close the supply path 58 and open the exhaust path 62. As a result, the compressed air inside the liner 12 is discharged to the outside from the exhaust path 62, and the internal pressure of the liner 12 is lowered.

When the first difference is a negative value and each of the second differences is a negative value, the pressure control unit 84 controls the operation of the supply valve 60 and the exhaust valve 64 to open the supply path 58 and close the exhaust path 62. As a result, the internal pressure of the liner 12 continues to increase.

When the first difference is 0 and the second differences are 0, the pressure control unit 84 controls the operation of the supply valve 60 and the exhaust valve 64 to open the supply path 58 and close the exhaust path 62. In the present embodiment, there is not a case where the first difference is positive and the second differences are negative, or where the first difference is negative and the second differences are positive. After step S6, the process transitions to step S7.

In step S7, the determination unit 86 determines whether or not the winding of the fiber member 14 is completed. If the winding of the fiber member 14 is not completed (NO in step S7), the process transitions to step S4. When the winding of the fiber member 14 is completed (YES in step S7), the process shown in FIG. 5 is completed.

After the processing of the filament winding method described above is completed, the liner 12 and the fiber layers 22 are heated. As a result, the fiber layers 22 are cured to form the reinforcing portion 20. Thereafter, the internal pressure of the liner 12 is reduced to atmospheric pressure.

According to the present embodiment, the following effects are obtained.

According to the present embodiment, the internal pressure of the liner 12 is feedback-controlled so that the intermediate outer dimension La approaches the first target value and the plurality of end portion outer dimensions Lb approach the plurality of second target values, respectively. Therefore, the balance between the internal pressure of the liner 12 and the winding force of the fiber member 14 can be appropriately maintained by simple control. Therefore, when the internal pressure of the liner 12 is lowered after the fiber member 14 is completely wound, it is possible to suppress the formation of a gap between the fiber layer 22 and the liner 12.

### Modified Embodiment

The present invention is not limited to the above-described embodiment, and various configurations can be adopted without departing from the gist of the present invention.

In the above embodiment, the example in which the acquisition unit 80 acquires the second distances L2 (the end portion outer dimensions Lb) at a plurality of positions has been described, but the acquisition unit 80 may acquire only the second distance L2 (the end portion outer dimension Lb) at one position. In the above embodiment, the FW device 10 includes the first distance measuring sensor 34 and the second distance measuring sensor 36, but the present invention is not limited thereto. The FW device 10 may include only one of the first distance measuring sensor 34 and the second distance measuring sensor 36. In this case, the first distance measuring sensor 34 or the second distance measuring sensor 36 can be omitted, so that the FW device 10 can be simplified. The second distance measuring sensor 36 may be disposed so as to face the second liner end portion 12c.

### Invention Obtained from Embodiment

The following describes the invention that can be understood from the above embodiment.

The filament winding device (10) according to an aspect of the present invention is configured to wind the fiber member (14) on the outer peripheral surface of the liner (12) made of resin and having the hollow shape in the state where the inside of the liner is pressurized. The filament winding device includes the acquisition unit configured to acquire the physical quantity (L1, L2) indicating the outer dimension (La, Lb) of the fiber layer (22) formed by winding the fiber member around the liner, during winding of the fiber member, and the pressure control unit (84) configured to control the internal pressure of the liner in the manner so that the outer dimension approaches the predetermined target value, during winding of the fiber member.

In accordance with such a configuration, since the internal pressure of the liner is controlled such that the outer dimension of the fiber layer approaches the predetermined target value, it is possible to appropriately maintain the balance between the internal pressure of the liner and the winding force of the fiber member by simple control. Therefore, when the internal pressure of the liner is lowered after finishing winding of the fiber member, it is possible to suppress the formation of a gap between the fiber layer and the liner.

In the filament winding device, the liner may include the liner intermediate portion (12a) having the cylindrical shape and located at the intermediate portion of the liner in the axial direction of the liner, and the acquisition unit may acquire the outer dimension of the fiber layer intermediate portion (22a) formed by winding the fiber member around the liner intermediate portion.

In accordance with such a configuration, when the internal pressure of the liner is lowered after finishing winding of the fiber member, it is possible to effectively suppress the formation of a gap between the fiber layer intermediate portion and the liner intermediate portion.

In the filament winding device, the liner may include the liner end portion (12b) having a hemispherical shape and located at the end portion of the liner in the axial direction of the liner, and the acquisition unit may acquire the outer dimension of the fiber layer end portion (22b) formed by winding the fiber member around the liner end portion.

In accordance with such a configuration, when the internal pressure of the liner is lowered after finishing winding of the fiber member, it is possible to effectively suppress the formation of a gap between the fiber layer end portion and the liner end portion.

The filament winding device may further include the difference calculation unit (82) configured to calculate the difference between the outer dimension and the target value, wherein the pressure control unit may feedback-control the internal pressure of the liner in the manner so that the difference is less than the predetermined difference threshold value.

In accordance with such a configuration, the feedback control of the internal pressure of the liner can be easily performed.

In the filament winding device, the target value may be acquired from the target value acquisition map defining the relationship between the winding amount of the fiber member around the liner and the target value of the outer dimension.

In accordance with such a configuration, the target value corresponding to the winding amount of the fiber member can be easily obtained from the target value acquisition map.

In the filament winding device, the acquisition unit may acquire the physical quantity using the distance measuring sensor (34, 36).

In accordance with such a configuration, the physical quantity indicating the outer dimension of the fiber layer can be easily obtained using the distance measuring sensor.

In the filament winding device, the distance measuring sensor may use laser light.

In accordance with such a configuration, the physical quantity indicating the outer dimension of the fiber layer can be easily obtained by the laser light.

In the filament winding device, the fiber member may be made of the fiber reinforced plastic.

Another aspect of the present invention is the filament winding method of winding the fiber member on the outer peripheral surface of the liner made of resin and having a hollow shape in the state where the inside of the liner is pressurized. The filament winding method includes acquiring the physical quantity indicating an outer dimension of the fiber layer formed by winding the fiber member around the liner, during winding of the fiber member (acquisition step, S4), controlling the internal pressure of the liner in the manner so that the outer dimension approaches the predetermined target value, during winding of the fiber member (pressure control step, S6).

The present invention is not limited to the above disclosure, and various modifications can be adopted therein without departing from the essence and gist of the present invention.

1. A filament winding device configured to wind a fiber member on an outer peripheral surface of a liner made of resin and having a hollow shape in a state where an inside of the liner is pressurized, comprising one or more processors that execute computer-executable instructions stored in a memory,
wherein the one or more processors execute the computer-executable instructions to cause the filament winding device to:
acquire a physical quantity indicating an outer dimension of a fiber layer formed by winding the fiber member around the liner, during winding of the fiber member; and
control an internal pressure of the liner in a manner so that the outer dimension approaches a predetermined target value, during winding of the fiber member.

2. The filament winding device according to claim 1, wherein the liner includes a liner intermediate portion having a cylindrical shape and located at an intermediate portion of the liner in an axial direction of the liner, and
the one or more processors cause the filament winding device to acquire an outer dimension of a fiber layer intermediate portion formed by winding the fiber member around the liner intermediate portion.

3. The filament winding device according to claim 1, wherein the liner includes a liner end portion having a hemispherical shape and located at an end portion of the liner in an axial direction of the liner, and
the one or more processors cause the filament winding device to acquire an outer dimension of a fiber layer end portion formed by winding the fiber member around the liner end portion.

4. The filament winding device according to claim 1, wherein the one or more processors execute the computer-executable instructions to cause the filament winding device to calculate a difference between the outer dimension and the target value, and
the one or more processors cause the filament winding device to feedback-control the internal pressure of the liner in a manner so that the difference is less than a predetermined difference threshold value.

5. The filament winding device according to claim 1, wherein the target value is acquired from a target value acquisition map defining a relationship between a winding amount of the fiber member around the liner and the target value of the outer dimension.

6. The filament winding device according to claim 1, wherein the one or more processors cause the filament winding device to acquire the physical quantity using a distance measuring sensor.

7. The filament winding device according to claim 6, wherein the distance measuring sensor uses laser light.

8. The filament winding device according to claim 1, wherein the fiber member is made of a fiber reinforced plastic.

9. A filament winding method of winding a fiber member on an outer peripheral surface of a liner made of resin and having a hollow shape in a state where an inside of the liner is pressurized, the method comprising:
acquiring a physical quantity indicating an outer dimension of a fiber layer formed by winding the fiber member around the liner, during winding of the fiber member; and
controlling an internal pressure of the liner in a manner so that the outer dimension approaches a predetermined target value, during winding of the fiber member.
